(19) United States
(12) Patent Application Publication
(10) Pub. No.: US 2025/0104514 A1
(43) Pub. Date: Mar. 27, 2025

(54) CRYPTOGRAPHIC TOKEN ENABLED PLAYER INFORMATION TRACKING

(71) Applicant: IGT, Las Vegas, NV (US)

(72) Inventors: Anthony BAERLOCHER, Henderson, NV (US); Stefan KEILWERT, St. Josef (AT); Michael RUSS, Graz (AT); Soheil LATIFI, Brampton (CA)

(73) Assignee: IGT, Las Vegas, NV (US)

(21) Appl. No.: 18/476,231

(22) Filed: Sep. 27, 2023

(51) Int. Cl. G07F 17/32; G06Q 20/36; G06Q 50/34

(52) U.S. Cl. CPC G07F 17/3239; G06Q 20/3672; G06Q 50/34; G07F 17/3244

(57) ABSTRACT

A processor circuit determines player information associated with a first player of a wagering game at a gaming device. The processor circuit embeds the player information in a cryptographic token. The processor circuit transfers the cryptographic token to a player wallet associated with the first player. The processor circuit, in response to the transfer, provides the embedded player information to a player tracking server.

### BACKGROUND

Embodiments described herein relate to game play features with wagering games, and in particular to a cryptographic token enabled player information tracking for wagering games in a gaming environment, such as in a casino environment, and related devices, systems, and methods. Some wagering games, such as slot games and/or video poker games provided at Electronic Gaming Machines (EGMs) and/or other gaming devices in a casino environment, may include information about the player of the wagering game and/or game play information obtained during game sessions at the device(s). There is a need for efficiently and securely providing this and other player information to different parties, such as gaming device manufacturer, wagering game provider, etc.

### BRIEF SUMMARY

According to some embodiments, a system includes a processor circuit and a memory coupled to the processor circuit. The memory comprises machine readable instructions that, when executed by the processor circuit, cause the processor circuit to determine player information associated with a first player of a wagering game at a gaming device. The instructions further cause the processor circuit to embed the player information in a cryptographic token. The instructions further cause the processor circuit to transfer the cryptographic token to a player wallet associated with the first player. The instructions further cause the processor circuit to, in response to the transfer, provide the embedded player information to a player tracking server.

According to some embodiments, a gaming device includes a display device, an input device, a processor circuit and a memory coupled to the processor circuit. The memory comprises machine readable instructions that, when executed by the processor circuit, cause the processor circuit to determine player information associated with a first player of a wagering game at a gaming device. The instructions further cause the processor circuit to embed the player information in a cryptographic token. The instructions further cause the processor circuit to display, by the display device. a machine-readable code comprising an instruction that, when scanned by a player device associated with a player wallet, causes the player device to transfer the cryptographic token to the player wallet. The instructions further cause the processor circuit to, in response to the transfer, provide the embedded player information to a player tracking server.

According to some embodiments, a method includes determining, by a processor circuit, player information associated with a first player of a wagering game at a gaming device. The method further includes embedding, by the processor circuit, the player information in a cryptographic token. The method further includes transferring, by the processor circuit, the cryptographic token to a player wallet associated with the first player. The method further includes, in response to the transfer, providing, by the processor circuit, the embedded player information to a player tracking server.

BRIEF DESCRIPTION OF SEVERAL VIEWS OF THE DRAWINGS

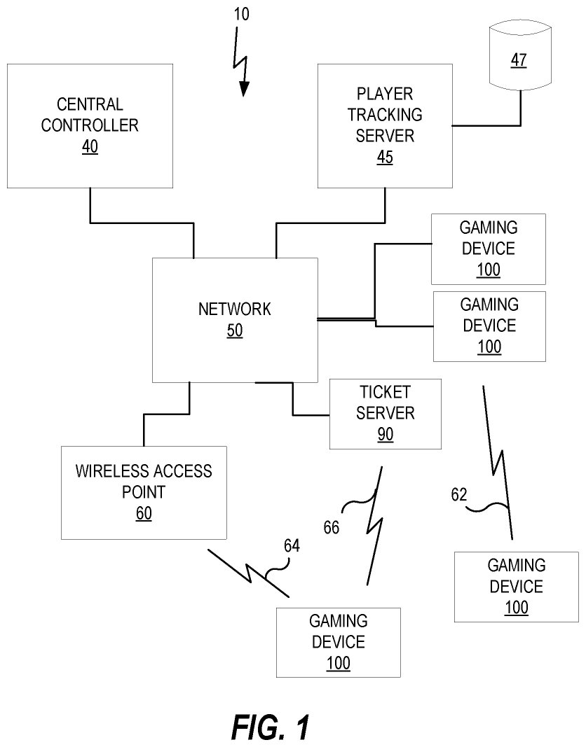

FIG. 1 is a schematic block diagram illustrating a network configuration for a plurality of gaming devices according to some embodiments.

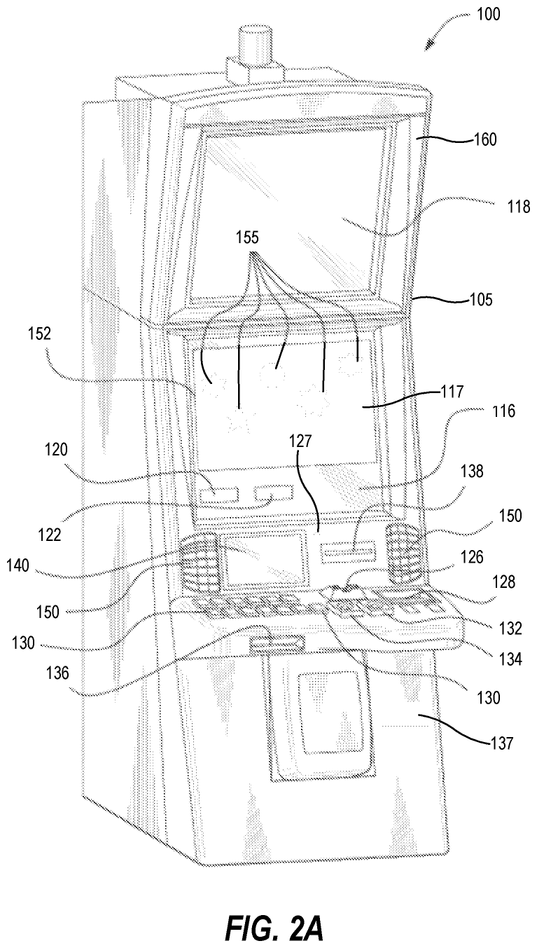

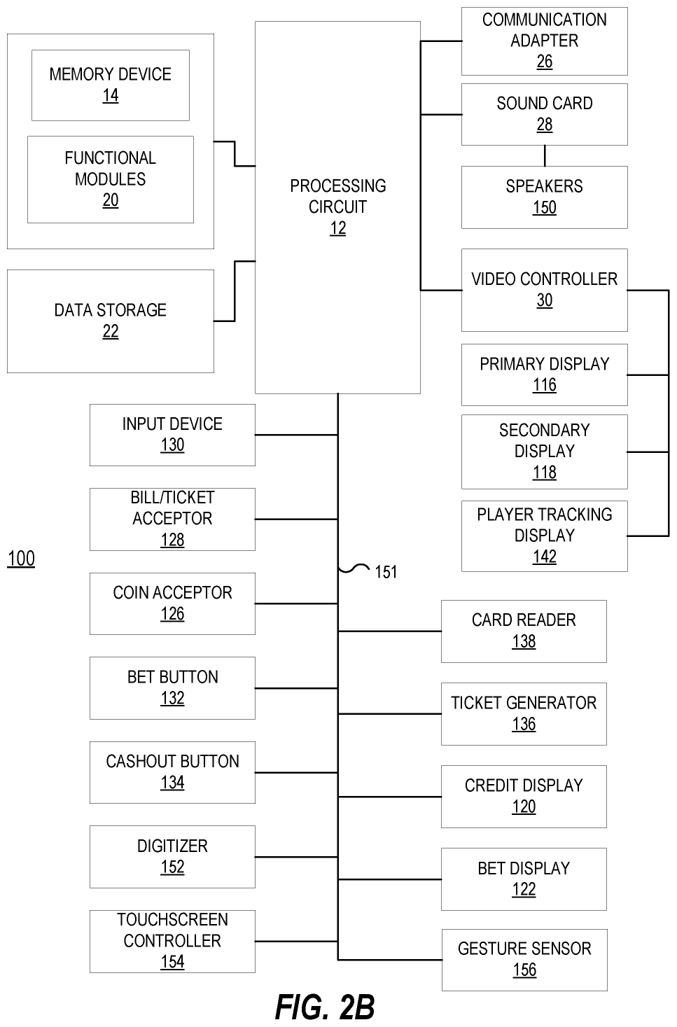

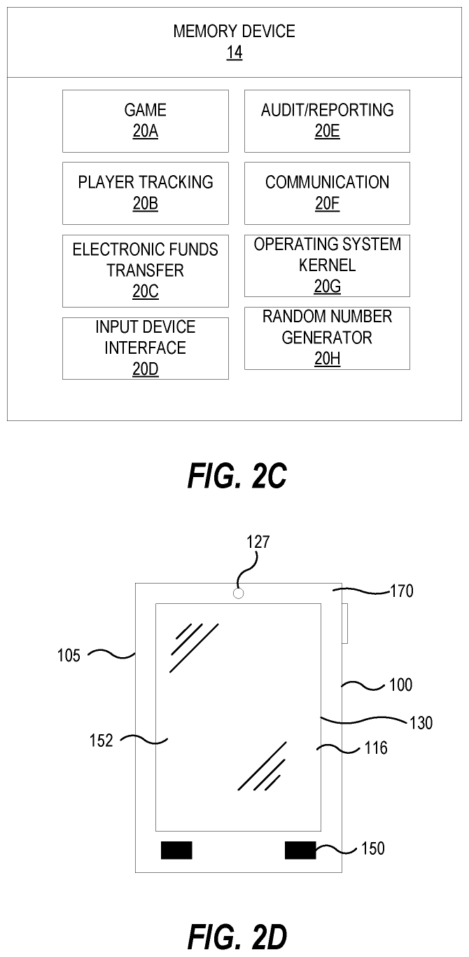

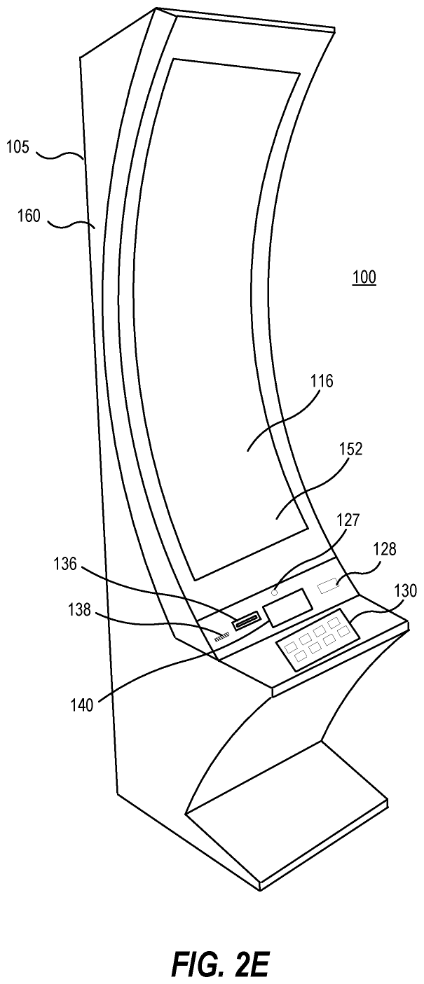

FIG. 2A is a perspective view of a gaming device that can be configured according to some embodiments.

FIG. 2B is a schematic block diagram illustrating an electronic configuration for a gaming device according to some embodiments.

FIG. 2C is a schematic block diagram that illustrates various functional modules of a gaming device according to some embodiments.

FIG. 2D is perspective view of a gaming device that can be configured according to some embodiments.

FIG. 2E is a perspective view of a gaming device according to further embodiments.

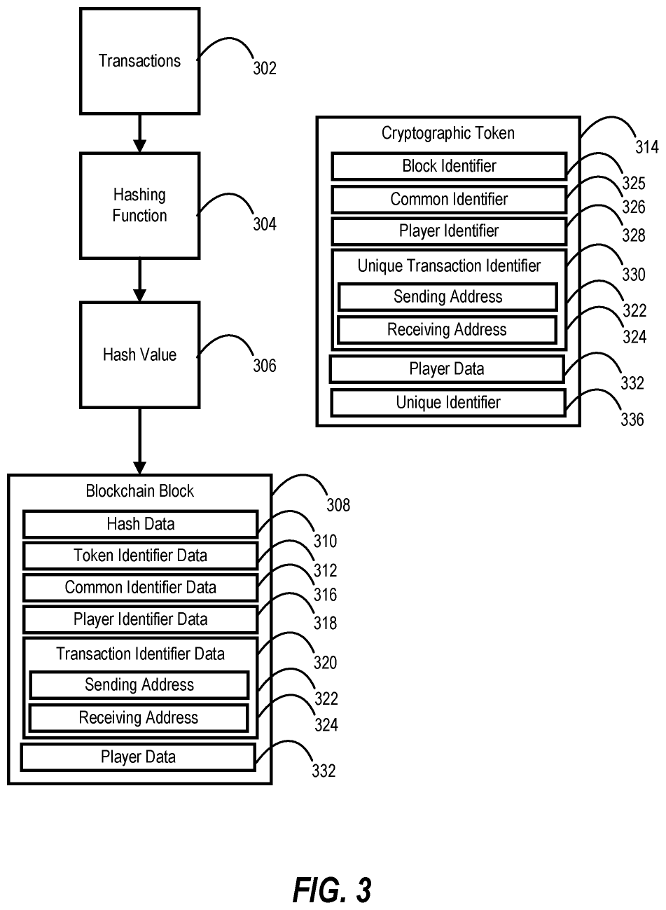

FIG. 3 is a schematic block diagram illustrating various operations for a blockchain token transaction according to some embodiments.

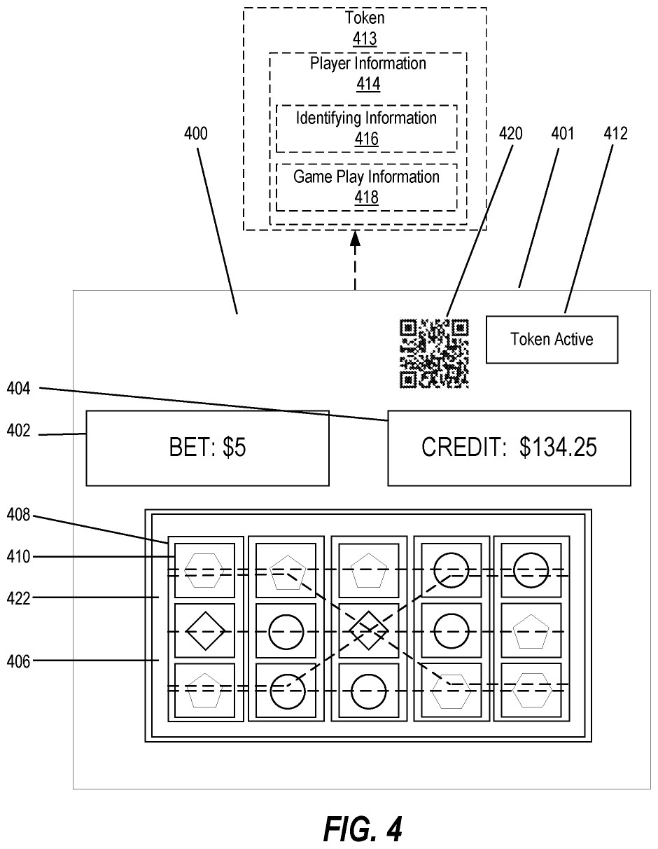

FIG. 4 illustrates a graphical user interface (GUI) for a gaming device embedding player information into a cryptographic token, according to some embodiments.

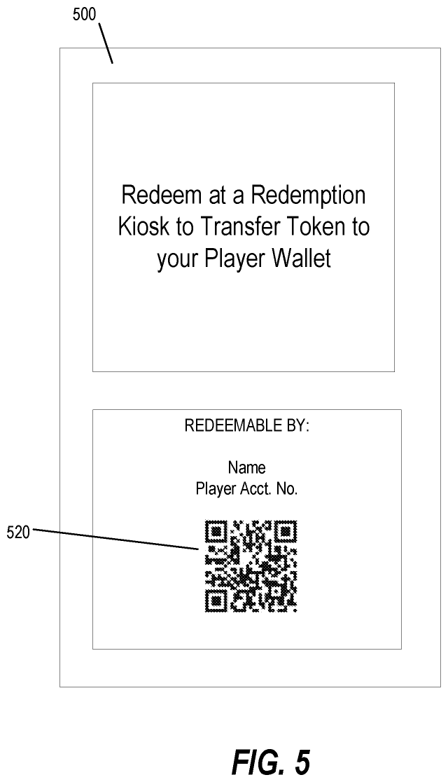

FIG. 5 illustrates a redemption ticket for transferring a cryptographic token to a player wallet and initiating transfer of player information to a player tracking server, according to another embodiment.

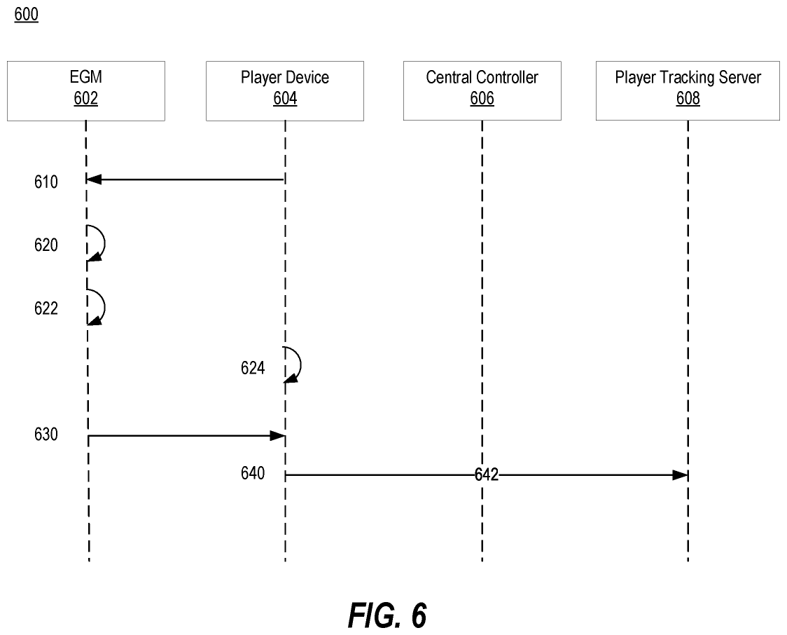

FIG. 6 illustrates a communication diagram of operations for embedding player information into a cryptographic token and transferring the player information to a player tracking server, according to some embodiments.

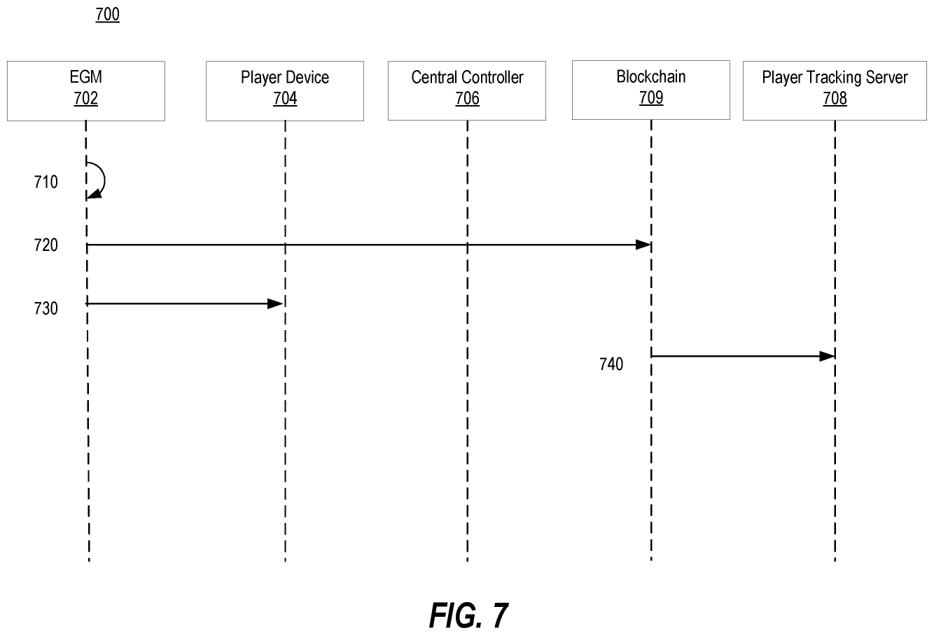

FIG. 7 illustrates a communication diagram of alternative and/or additional operations for embedding player information into a cryptographic token and transferring the player information to a player tracking server, according to some embodiments.

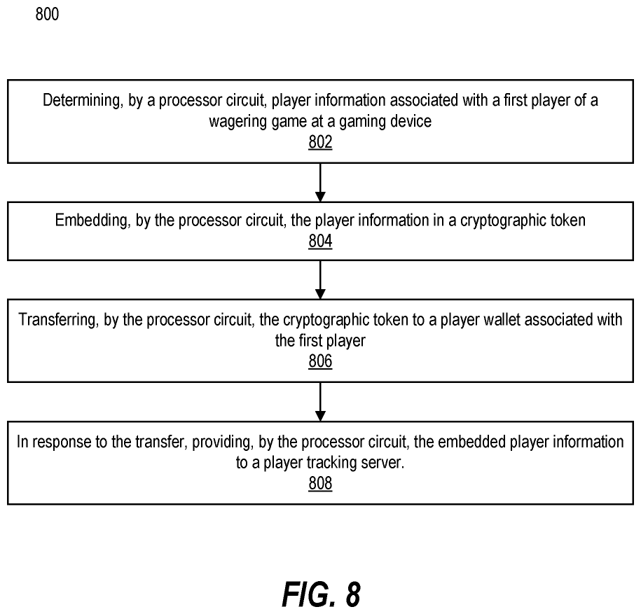

FIG. 8 is a flowchart illustrating operations of systems/methods of embedding player information into a cryptographic token and transferring the player information to a player tracking server, according to some embodiments.

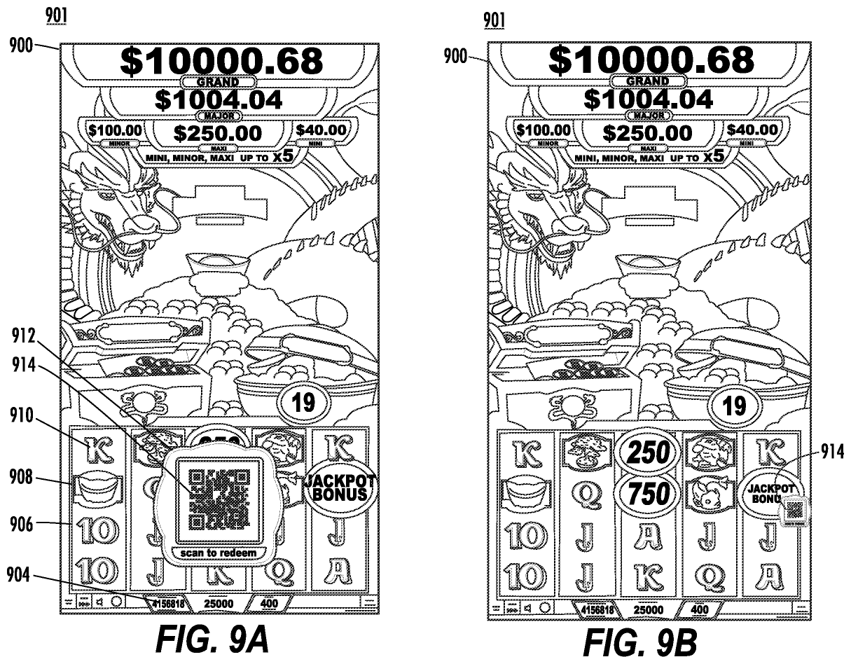

FIGS. 9A and 9B illustrate a graphical user interface (GUI) for a gaming device awarding a cryptographic token having embedded player information, according to some embodiments.

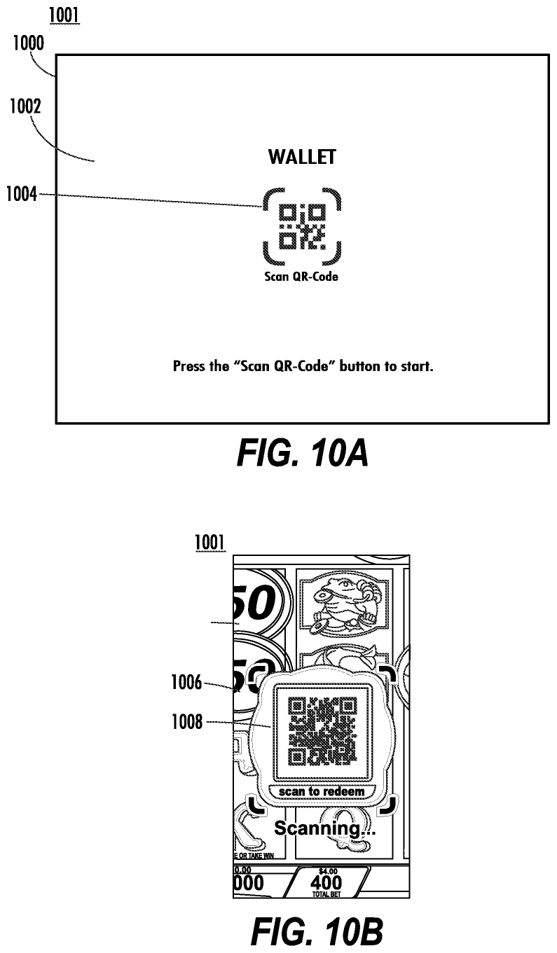

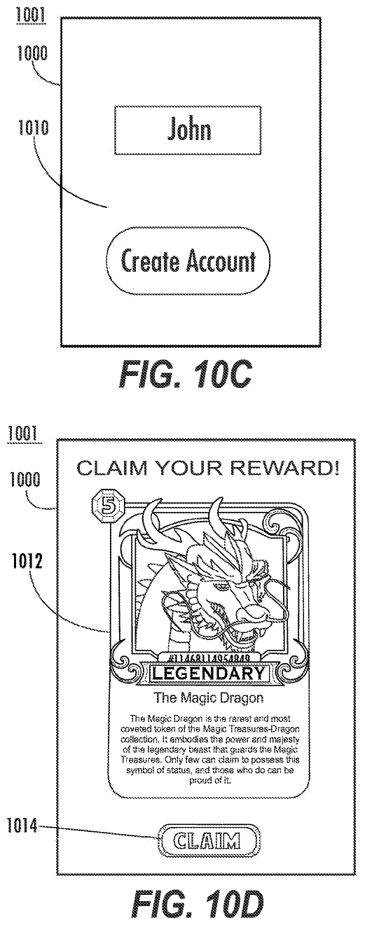

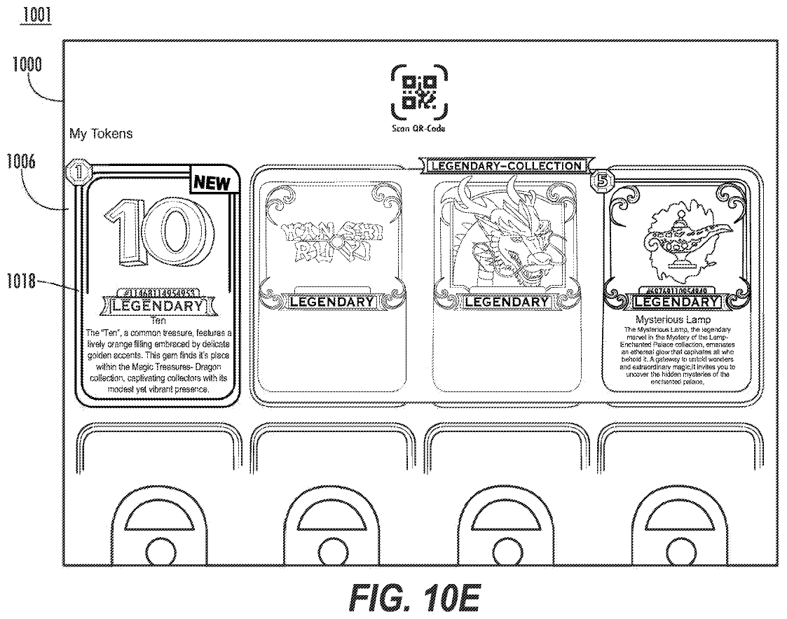

FIGS. 10A-10E illustrate a graphical user interface (GUI) for a mobile device 1001 for collecting the cryptographic token award of FIGS. 9A and 9B, according to some embodiments.

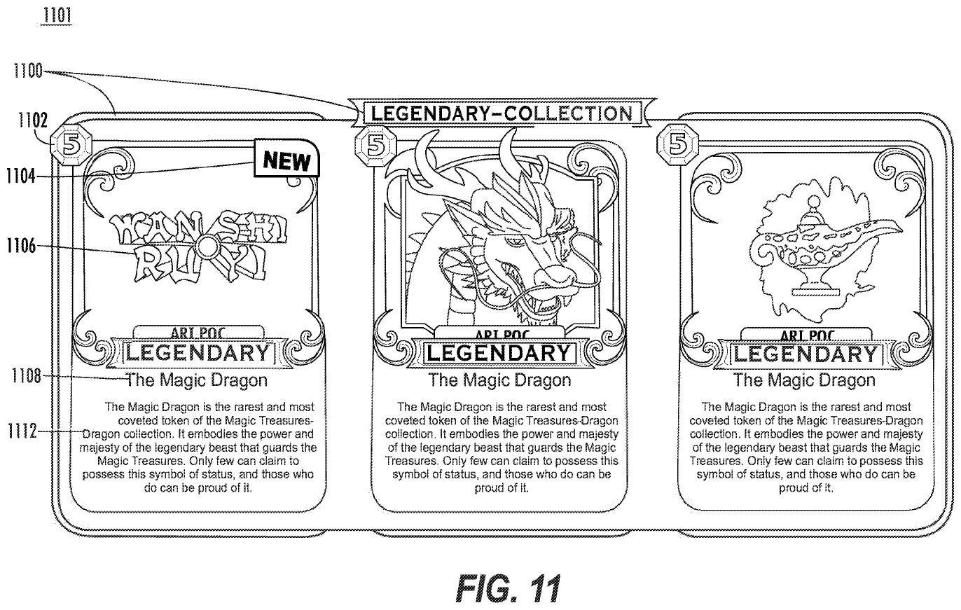

FIG. 11 illustrates a collection of tokens that may be awarded, according to some embodiments.

### DETAILED DESCRIPTION

Embodiments described herein relate to game play features with wagering games, and in particular to a cryptographic token enabled player information tracking for wagering games in a gaming environment, such as in a casino environment, and related devices, systems, and methods. In some embodiments, a processor circuit may determine player information associated with a first player of a wagering game at a gaming device. The processor circuit may embed the player information in a cryptographic token. The processor circuit may transfer the cryptographic token to a player wallet associated with the first player. The processor circuit, in response to the transfer, may provide the embedded player information and other information to a player tracking server. For example, as used herein, player information may include identifying information about a player of a wagering game and/or game play information related to the player's play of the wagering game, such as a player name, account number, address, email, etc., and/or game play information associated with play of the wagering game at the gaming device by the player, such as amounts wagered, amounts won, bets placed, etc., as well as other information such as performance data, gaming device status, gaming device ID, game titles, software version, etc.

Traditionally, obtaining reliable information about casino player behavior and/or performance is difficult for operators and manufacturers. In many cases, operators may be reluctant to provide data to a loyalty system between players and manufacturers, particularly when the operator may bear an administrative burden for the manufacturer's benefit and/or when an operator's own loyalty system may be bypassed by the manufacturer's system.

According to some embodiments, player data may be collected and transferred to manufacturers directly using a cryptographic token system. For example, eligibility conditions may be tied to awards of cryptographic tokens, which may provide direct insight into player behavior related to the eligibility conditions based on how cryptographic tokens are awarded. Player data may also be collected through the cryptographic token and/or its blockchain-stored information directly. For example, token reward information, game play requirements, game play statistics, etc. might directly be stored in the blockchain, as well as player identification data, without the need to access a casino or other operator's own loyalty system data. In this manner, information can be collected for player from different venues and different operators, and the manufacturer may reward loyal players directly, e.g., by awarding, minting, and/or otherwise providing cryptographic tokens and benefits. In some examples, the manufacturer may provide personalized awards at a later time or different location, e.g., mailed to a player's residence based on previous casino game play.

Cryptographic tokens and benefits may be earned by players in a number of ways that may incentivize the players to participate and consent to data collection, such as an achievement hunt, club membership granting exclusive access to special events, focus groups, early access content, and/or other promotions.

The operator may also benefit from increased player game play and engagement without the need for administering the manufacturer's token based features.

Advantages of these and other embodiments may include enhancement or replacement of existing player loyalty programs, additional insights into players' performance and behavior data, enabled through the cryptographic tokens, easier direct access to player data without operator involvement or manual data retrieval or entry, and binding players to the manufacturer's loyalty program and driving traffic to the manufacturer's games.

In some embodiments, cryptographic tokens, such as fungible and/or non-fungible tokens for example, may be minted by a game manufacturer and can be made available to players in various ways, such as through winning tokens through gameplay, purchasing tokens online, trading, random gifting, etc. In some examples, game components such as symbols, animated symbols, sounds, music, game characters, etc. for the manufacturer's game may be converted and/or incorporated into tokens by minting. The manufacturer may define a number of available tokens, minting frequency, each token's initial trading value, transaction fees (e.g., 1% to the manufacturer for each token transaction), etc. Proof of ownership may be provided in the blockchain associated with the token.

In some embodiments, minting cryptographic tokens may occur in response to predetermined game events and/or conditions. For example, in-game events such as 5-of-a-kind symbol wins, jackpot triggers, bonus-wins, and other events may trigger minting and/or awarding a cryptographic token, while other events that are not included in the set predetermined game events may not qualify for a mint and/or cryptographic token award. In some examples, the type of cryptographic token that may be minted and/or awarded may be based on rarity and/or scarcity of the triggering event. For example, a high-value jackpot win may increase the chance for minting a scarcer type of cryptographic token. In some examples, minting can occur randomly or semi-randomly. For example, criteria for random minting and/or awarding a cryptographic token may include a number of games played during the lifetime of a specific game title, e.g., on a particular machine, group of machines and/or across all machines), total revenue for a wagering game within a particular time period, etc. For example, between 100,000 and 110,000 games played for a particular game, each game may include a chance to randomly mint and/or award a cryptographic token.

In some examples, other non in-game events may trigger minting and/or awarding cryptographic tokens, e.g., from an external source such as connection of a gaming device to a casino system network, such that tokens may be randomly minted and the result may be displayed on the gaming device display. In some examples, non-random events such as a player tiering up in a loyalty program, may trigger minting and/or awarding of a cryptographic token, with the result displayed on the gaming device display.

In some examples, tokens may be purchased right after the minting progress (e.g., purchased directly from a manufacturer's token portal), purchased from a reseller (e.g., another casino player), be earned through gameplay, e.g., earning achievements, and/or by random awards, e.g., “air drops” for selected or randomly assigned players.

In some examples, a participating player may have ownership of and/or access to a personal wallet, which may be a standalone device and/or may be integrated into a player device, such as a mobile phone, for example. During the transfer process, player data may be automatically transmitted to the manufacturer for further processing & analyses. In this manner, data collection may be obtained seamlessly, initiated directly by the player and being transmitted directly to the manufacturer. In addition, these features may be used to create a loyalty system between the manufacturer and the player, directly without incurring any monetary or administrative costs for the operator.

In some examples, based on an eligible win or other event, an EGM may creates an ID for a token reward tier. The token ID may be provided to a reward engine, which may be blockchain or database-based, and translated into a token, which may be minted in real time and/or selected from a pool of available tokens. Token information may be provided to the EGM and presented to the player and/or may be transferred directly into the player wallet and/or loyalty database account.

In some examples, an EGM may access a blockchain data structure and/or database and may mint and/or transfer the token directly, using EGM computing resources. In some examples, the token content (e.g., visuals, sound, text, etc.) may be derived from the game software and can be presented to the player without the need of a dedicated content-server. In some examples, the token content can be hosted on a dedicated server and pulled from there into the game for presentation purposes.

In some examples, tokens may be stored in a player wallet, which may track token ownership and stored token content (e.g., visuals, sound, text, etc.). Alternatively, tokens and their content may be stored in the blockchain, in fully-encrypted, partially encrypted, or unencrypted form, as desired. For example, some data may be unencrypted and publicly viewable on the blockchain, e.g., data that is anonymous or may be anonymized. For more sensitive personal information, such data may be encrypted within the blockchain such that a unique private key may be used for the player, manufacturer, operator, or other authorized party may access the information while preventing the general public from viewing the information.

In some examples, a player wallet may track token ownership while the token content may be hosted on a separate server. The wallet may be stored on a player's device and/or on a dedicated server, as desired. In some examples, tokens may be stored and managed on a separate, independent server infrastructure, in parallel to existing casino infrastructure, and/or in connection with casino infrastructure, e.g., integrated into existing casino player accounts.

In some examples, token transfers may be initiated by displaying a machine readable code, e.g., a QR code or bar code for example, with an embedded token ID, which may be scanned by a mobile device to read the token ID and initiate the transfer transaction. In some examples, wireless protocols such as Wifi, Bluetooth, NFC, RFID, etc., may be used to facilitate device communications and initiate transactions. In some examples, transfer information may be associated with a player's casino account and the token transfer may be executed through an external network.

In some examples, additional information may be included in a machine-readable code, with code complexity and/or data transfers being adjusted dynamically based on amounts of data to be transmitted. Examples of player data that may be tracked may include session performance data, such as average bet, cash in, number of games, number of sessions, game-titles, denomination, game configuration, etc. Additional information may include anonymous play, player, and/or playstyle data, such as identifying game events, cash transfers, bet behavior, session length/etc. Personalized play and/or playstyle data may tie the above data to a player's identifying information, such as name, player account, account number, etc. Information about player owned tokens and other rewards may also be tracked, e.g., to avoid awarding duplicate tokens to certain players for example. Storage of the data and/or tokens may be centralized, e.g., independently of the token on a network and/or server, or decentralized, e.g., incorporated into the token metadata and/or stored in an associated blockchain data structure.

In some embodiments, transfer of tokens to a player wallet may be initiated by scanning a machine readable code with a mobile device camera, which may prompt a player wallet application on the mobile device to open. Upon authentication and/or login, the token ownership may be transferred, and player information may be provided to the manufacturer. In some examples, the player wallet may be hosted on a player's mobile device, e.g., in a mobile application, by a custodian, e.g., by the manufacturer or a third part, and/or centrally or in a distributed manner in one or more internet servers. In some examples, the player wallet may be registered in a venue, e.g., a casino. The player wallet may be created and/or hosted via a casino network and/or gaming device, and/or may be a third party wallet that is linked to the casino network and/or gaming device, as desired. In some examples, a player wallet may be accessed via a gaming device, e.g., initiated via a mobile device authentication, or via direct authentication with the gaming device.

In some examples, a player may have the option to immediately sell a token award without first transferring the token to a player wallet. For example, a gaming device may have an option to sell a token automatically on a token marketplace rather than create and/or access an existing wallet. In some examples, a transaction fee may be provided to the manufacturer, operator, or other third party for these and other transactions. In some examples, a gaming device may be configured to automatically associate token awards with a player's tracking account, which may permanently or temporarily store the token before transferring the token to a player wallet. For example, if a player is unable to authenticate a wallet transaction, the gaming device may save the token to be transferred at a later time, e.g., at casino check out for example, with actual ownership of the token remaining with the provider until the wallet transfer is completed. This may streamline the token award process and reduce interruption in game play. In some examples, token attributes, such as value, type, assets, etc., may be visible or invisible to the player before claiming, as desired.

In some examples, the machine readable code may include or be integrated into a graphic, e.g., the token graphic for example, or theme.

In some examples, a token award may be based on predetermined conditions and/or gaming achievements. For example, a token trigger condition may indicate a certain threshold, condition, and/or event that is of interest to the manufacturer. Based on the creation and/or awarding of tokens based on these conditions, the manufacturer may obtain data related to these conditions.

In some examples, after a token award is triggered, the gaming device may transfer both the token and the player data to the player's device, which then may automatically upload the player data to a central online location. In some examples, token awards may be obtained directly from the manufacturer, rather than an operator. For example, the gaming device may request a token to be awarded from the manufacturer, and in return may be asked to transmit the respective player data. In some examples, if a gaming device is not connected to the internet, the player's internet-connected mobile device may manage some or all of the transaction.

In some examples, the player information may include anonymized data, such as game events, cash or credit transfers, bet behaviors, session length, etc., or may include personalized data tied to particular players, e.g., tied to a player's name, account, ID, etc., and/or tokens or other awards owned or associated with the player.

In some examples, players may be reimbursed, e.g., through promotional offers such as coupons, discounts etc., or monetary payment, in exchange for modified data collection, such as non-anonymized data collection, which may also benefit the player through a more personalized gaming experience. Players may submit their own tokens to be included in the data collection system.

In some examples, players may personalize their tokens, e.g., adding a player's signature to make it unique to the player.

In some examples, players may choose to keep their data history after selling or transferring a token, applying the data history to a new token if desired.

Before describing these and other features in greater detail, reference is now made to FIG. 1, which illustrates a gaming system 10 including a plurality of gaming devices 100. The gaming devices 100 may be one type of a variety of different types of gaming devices, such as electronic gaming machines (EGMs), mobile gaming devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processing circuit and at least one memory or storage device. Each gaming device 100 may include a processing circuit that transmits and receives events, messages, commands or any other suitable data or signal between the gaming device 100 and the central controller 40. The gaming device processing circuit is operable to execute such communicated events, messages or commands in conjunction with the operation of the gaming device 100. Moreover, the processing circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processing circuits. Moreover, in some embodiments, one or more of the functions of one or more gaming device processing circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processing circuit that transmits and receives events, messages, commands or any other suitable data or signal between the ticket server 90 and the central controller 40. The ticket server 90 processing circuit may be operable to execute such communicated events, messages or commands in conjunction with the operation of the ticket server 90. Moreover, in some embodiments, one or more of the functions of one or more ticket server 90 processing circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

Embodiments herein may include different types of gaming devices. One example of a gaming device includes a gaming device 100 that can use gesture and/or touch-based inputs according to various embodiments is illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A to 2C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of standard features, many of which are illustrated in FIGS. 2A and 2B. For example, referring to FIG. 2A, a gaming device 100 (which is an EGM 160 in this embodiment) may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIG. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously-placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as gesture sensors 156 for gesture input devices, and/or a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processing circuit 12 or directly from a memory device 14 and displays the video data on the display screen. The credit display 120 and the bet display 122 are typically implemented as simple liquid crystal display (LCD) or light emitting diode (LED) displays that display a number of credits available for wagering and a number of credits being wagered on a particular game. Accordingly, the credit display 120 and the bet display 122 may be driven directly by the processing circuit 12. In some embodiments however, the credit display 120 and/or the bet display 122 may be driven by the video controller 30.

Referring again to FIG. 2A, the display devices 116, 118, 140 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touch-screen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket dispenser 136, a bill/ticket acceptor 128, and a coin acceptor 126 that allows the player to deposit coins into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processing circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processing circuit 12 that controls operations of the gaming device 100. Although illustrated as a single processing circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processing circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processing circuit 12. It will be appreciated that the components may be connected to the processing circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processing circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, Digital Video Disc (“DVD”) or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player.

The gaming device 100 may include one or more internal or external communication ports that enable the processing circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processing circuit through a USB hub (not shown) connected to the processing circuit 12.

In some embodiments, the gaming device 100 may include a sensor, such as a camera 127, in communication with the processing circuit 12 (and possibly controlled by the processing circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processing circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

In some embodiments, a gaming device 100 includes a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

For example, referring to FIG. 2D, a gaming device 100 (which is a mobile gaming device 170 in this embodiment) may be implemented as a handheld device including a compact housing 105 on which is mounted a touchscreen display device 116 including a digitizer 152. One or more input devices 130 may be included for providing functionality of for embodiments described herein. A camera 127 may be provided in a front face of the housing 105. The housing 105 may include one or more speakers 150. In the gaming device 100, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card reader, secondary displays, a bet display, a credit display, etc. Credits can be deposited in or transferred from the gaming device 100 electronically.

FIG. 2E illustrates a standalone gaming device 100 (which is an EGM 160 in this embodiment) having a different form factor from the EGM 160 illustrated in FIG. 2A. In particular, the gaming device 100 is characterized by having a large, high aspect ratio, curved primary display device 116 provided in the housing 105, with no secondary display device. The primary display device 116 may include a digitizer 152 to allow touchscreen interaction with the primary display device 116. The gaming device 100 may further include a player tracking display 142, an input device 130, a bill/ticket acceptor 128, a card reader 138, and a bill/ticket dispenser 136. The gaming device 100 may further include one or more cameras 127 to enable facial recognition and/or motion tracking.

Although illustrated as certain gaming devices, such as electronic gaming machines (EGMs) and mobile gaming devices, functions and/or operations as described herein may also include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

Referring now to FIG. 3, a schematic block diagram illustrates various operations for a blockchain transaction recordation according to some embodiments. As illustrated in FIG. 3, transactions 302 may occur at various blockchain nodes. In accordance with various embodiments, a hash may be created for each entry. For example, a cryptographic hash function may create a one-way, (essentially) collision free signature of the entry. The hash algorithm generates a hash. Using hashing function 304, hash values 306 of these transactions are created and added to blockchain blocks 308 that are in the blockchain data structure.

In this example, each blockchain block 308 may include one or more different types of data. For example, each blockchain block 308 may include cryptographic hash data 310 indicative of a result of the hashing function 304 associated with a common blockchain, token identifier data 312 indicative of an identity of a cryptographic token 314 associated with the block 308, common identifier data 316 indicative of the cryptographic token 314 being part of a plurality of cryptographic tokens, e.g., a defined subset of tokens based on different criteria, associated with the common blockchain, player identifier data 318 indicative of an identity of a player associated with the cryptographic token 314, transaction identifier data 320 associated with the unique transaction on the blockchain, which may include a sending address 322 associated with a provider of the cryptographic token 314 and a receiving address 324 associated with the player identifier data 318.

The cryptographic token 314 may include some or all of the data structure of the respective associated block 308 and/or may contain a block identifier 325 referring to the associated block 308, which allows the cryptographic token 314 to be securely and transparently authenticated against the blockchain. In some examples, the cryptographic token 314 may include a common identifier 326 corresponding to the common identifier data 316 and indicative of the cryptographic token 314 being part of the plurality of cryptographic tokens, and a player identifier 328 corresponding to the player identifier data 318 and indicative of a player associated with the cryptographic token 314. The cryptographic token 314 may include a unique transaction identifier 330 associated with a unique transaction on the blockchain, i.e., a unique block 308, and may include the sending address 322 and/or the receiving address 324.

For example, a new transaction for the cryptographic token may include transmitting a transaction indication of the new transaction including a sending address 322 and receiving address 324, and, based on the transaction indication, modifying the player identifier data 318 in a new block 308 and/or the player identifier 328 of the cryptographic token 314 to be indicative of a different player.

In some examples, each block 308 may further include player data 332 containing and/or indicative of player information embedded in the blockchain block 308. Alternatively or in addition, the cryptographic token 314 may include player data 334 containing and/or indicative of the player information and/or player data 332. Each cryptographic token 314 may be a fungible token that is fungible with other cryptographic tokens, and/or may further include a unique identifier 336, which may correspond to the token identifier data 312 of the block 308, such that the cryptographic token 314 is a non-fungible token that is not fungible with other cryptographic tokens.

As a general principle, a validation process may be performed to ensure that each new blockchain block 308 meets the criteria for inclusion into the blockchain data structure. In a blockchain configuration, there are varying consensus algorithms that can be used. For example, a private blockchain may choose an algorithm such as Practical Byzantine Fault Tolerance (PBFT). The PBFT mechanism may be useful for small networks, such as networks having fewer than about 100 nodes. Other examples include a Proof of Work (PoW) consensus algorithm and/or a Proof of Stake (PoS) consensus algorithm, which may be used as the value of an underlying data block and/or value changes.

Referring now to FIG. 4, a graphical user interface (GUI) 400 is illustrated for a gaming device 401 embedding player information into a cryptographic token, according to some embodiments. The GUI 400 may include a bet button 402, a credit meter 404, and a plurality of game elements 406 for a wagering game, such as a plurality of slot reels 408 and slot symbols 410 for example. In this example, the GUI 400 may further include a token indicator 412 indicative of an active cryptographic token 413 associated with the player.

Player information 414 may be embedded in the cryptographic token during or following play of the wagering game by the first player. Player information 414 may include identifying information 416, such as a player name, account number, address, email, etc., and/or game play information 418 associated with play of the wagering game at the gaming device by the player, such as amounts wagered, amounts won, bets placed, etc. These and other types of player information 414 are typically available to the operator of the gaming device, but may not be automatically provided to a gaming device manufacturer or a provider of the wagering game. By embedding this and other types of information in a cryptographic token, the player information 414 may be provided to non-operator third parties more easily, without operator involvement or permission.

Embedding the player information 414 in the cryptographic token may be accomplished by the gaming device or associated device minting the cryptographic token with the embedded player information 414, which may then be provided to the player. Alternatively, or in addition, embedding the player information 414 in the cryptographic token may include modifying an existing cryptographic token, such as a cryptographic token already owned by the player, or a previously minted cryptographic token that may be transferred to the player following the embedding of the player information 414, for example.

As an incentive for the player to allow the player information 414 to be embedded in the cryptographic token, the cryptographic token may have an independent value and/or benefit for the player, such that the cryptographic token may be transferred to a player wallet associated with the player for later use and/or redemption by the player. In this embodiment, as part of the transfer, the embedded player information 414 is also provided to a player tracking server for use by the gaming device manufacturer, provider of the wagering game, and/or other third party.

In some embodiments, the GUI 400 may display a machine-readable code 420, such as a QR code, that includes an encoded instruction to redeem the cryptographic token, such that a player device (e.g., a mobile phone) associated with the player wallet scanning the code causes the player device to execute the instruction to transfer the cryptographic token to the player wallet.

As shown by FIG. 5, in some embodiments, a ticket printer device of the gaming device may print a redemption ticket 500 that includes a machine-readable code 520 that operates similarly to the machine-readable code 420 of FIG. 4. In response to scanning the code 520 at a ticket redemption device (e.g., a redemption kiosk, a player device, etc.), the embedded instruction to transfer the cryptographic token to the player wallet is executed.

FIG. 6 illustrates a communication diagram of operations 600 for embedding player information into a cryptographic token and transferring the player information to a player tracking server, according to some embodiments. In this example, an EGM 602 may wirelessly receive an instruction to redeem 610 the cryptographic token from a player device 604 associated with the player, which causes the EGM 602 to transfer 630 the cryptographic token to a player wallet, e.g., the player device 604 in this example

The operations 600 may further include embedding 620 player information into the cryptographic token and providing 640 the embedded player information to the player tracking server 608, e.g., via the player device 604 transmitting 642 the embedded player information to the player tracking server 608.

In some embodiments, the EGM 602 may display a machine-readable code 622, such as a QR code, that includes the encoded instruction to redeem the cryptographic token, such that the player device 604 associated with the player wallet scanning the code causes the player device 604 to execute the instruction to transfer 630 the cryptographic token to the player wallet.

FIG. 7 illustrates a communication diagram of alternative and/or additional operations 700 for embedding player information into a cryptographic token and transferring the player information to a player tracking server, according to some embodiments.

In this example, an EGM 702 may determine 710 player information, such as identifying information and/or game play information, and embed 720 the player information in a first block of a blockchain data structure 709 associated with the cryptographic token. The player information may be encrypted before or as part of embedding the player information in the blockchain data structure 709. The embedding may occur as part of or in connection with a transfer 730 of the cryptographic token to the player wallet, e.g., a player device or other device.

The player tracking server 708 and/or central controller 706 may then retrieve 740 the player information from the blockchain data structure, e.g., by determining the first block of the blockchain data structure 709 and extracting the player information from the first block, which may include decrypting the player information.

FIG. 8 is a flowchart illustrating operations 800 of operations of systems/methods of embedding player information into a cryptographic token and transferring the player information to a player tracking server, according to some embodiments. The operations 800 may include determining, by a processor circuit, player information associated with a first player of a wagering game at a gaming device (Block 802). The operations may further include embedding, by the processor circuit, the player information in a cryptographic token (Block 804). The operations may further include transferring, by the processor circuit, the cryptographic token to a player wallet associated with the first player (Block 806). The operations may further include, in response to the transfer, providing, by the processor circuit, the embedded player information to a player tracking server (Block 808).

FIGS. 9A and 9B illustrate a graphical user interface (GUI) 900 for a gaming device 901 awarding a cryptographic token having embedded player information, according to some embodiments. Similar to the GUI 400 of FIG. 4, the GUI 900 may include a credit meter 904 and a plurality of game elements 906 for a wagering game, such as a plurality of slot reels 908 and slot symbols 910 for example.

As shown by FIG. 9A, a winning game result may include a token award 912, and may display a QR code 914 or other machine readable code with instructions to scan the QR code 914 with the player's mobile device camera. In this example, the QR-code 914 is superimposed on the reels 908, and as shown by FIG. 9B, the QR code 914 may reduce in size and move to a less conspicuous part of the GUI 900 after a predetermined amount of time to allow the player to resume play while retaining the ability to scan the QR code 914 and collect the token award 912.

FIGS. 10A-10E illustrate a graphical user interface (GUI) 1000 for a mobile device 1001 for collecting the cryptographic token award 912 of FIGS. 9A and 9B, according to some embodiments. As shown by FIG. 10A, a mobile application may include a landing page 1002 with a scan button 1004 to initiate scanning the QR code 914 of FIGS. 9A and 9B. As shown by FIG. 10B, a camera window 1006 allows the player to line up a camera image 1008 of the QR code 914 to scan the QR code 914.

As shown by FIG. 10C, the player is prompted 1010 to log into a player wallet and/or create a new player wallet. As shown by FIG. 10D, after successful account login and/or creation, the token award 1012 is shown and the player is prompted to claim 1014 the award 1012.

As shown by FIG. 10E, after the token award 1012 is claimed, the player wallet 1016 may be displayed, showing tokens 1018 collected and owned by the player, including the newly acquired token award 1012. Selecting a token 1018 may display more information and interaction options with the token 1018, if available, such as pictures, animations, sounds, detailed descriptions, etc., trading, selling, and/or buying options, and/or the token's 1018 current market value.

FIG. 11 illustrates a collection 1101 of tokens 1100 that may be awarded, according to some embodiments. In this example, the token 1100 may include a tier level 1102, which may indicate an additional attribute, or trait, which reflects their level of rarity. For example, in this embodiment, the available tier levels may range from 1-5, while 1 is little rare to 5 is highly rare. Tier levels 1102 assigned to a token may also correspond to the rarity level of the underlying game event that mints the tokens. Tier levels 1102 may be displayed visually on the token 1100, e.g., as a number, graphically in color, graphically by level of detail, statically, and/or animated. In this embodiment, each token 1100 at the same tier level 1102 may have the same or similar rarity levels.

The token 100 may also include a novelty flag 1104, indicating whether the token 1100 has been made available within a predetermined period of time. The token 1100 may include a graphical token symbol 1106 and a token name 1108, a unique identifier 1110, and a token description 1112 for identifying and describing the token 1100. The token 1100 may include a tier indicator 1114, which may correspond to a rarity of the token 1100, and a stackable flag 1116, which may indicate that two tokens 1100 of a same kind in a lower tier can be combined (e.g., “stacked”) to one new token of the same kind in a higher tier, thereby becoming more valuable and/or scarce, and/or may provide new or additional benefits that may be better than benefits provided by the individual tokens 1100 prior to stacking. In some examples, stacking can occur automatically and/or initiated by the owner.

Embodiments described herein may be implemented in various configurations for gaming devices 100, including but not limited to: (1) a dedicated gaming device, wherein the computerized instructions for controlling any games (which are provided by the gaming device) are provided with the gaming device prior to delivery to a gaming establishment; and (2) a changeable gaming device, where the computerized instructions for controlling any games (which are provided by the gaming device) are downloadable to the gaming device through a data network when the gaming device is in a gaming establishment. In some embodiments, the computerized instructions for controlling any games are executed by at least one central server, central controller or remote host. In such a “thin client” embodiment, the central server remotely controls any games (or other suitable interfaces), and the gaming device is utilized to display such games (or suitable interfaces) and receive one or more inputs or commands from a player. In another embodiment, the computerized instructions for controlling any games are communicated from the central server, central controller or remote host to a gaming device local processor and memory devices. In such a “thick client” embodiment, the gaming device local processor executes the communicated computerized instructions to control any games (or other suitable interfaces) provided to a player.

In some embodiments, a gaming device may be operated by a mobile device, such as a mobile telephone, tablet other mobile computing device. For example, a mobile device may be communicatively coupled to a gaming device and may include a user interface that receives user inputs that are received to control the gaming device. The user inputs may be received by the gaming device via the mobile device.

In some embodiments, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more gaming devices; and/or (c) one or more personal gaming devices, such as desktop computers, laptop computers, tablet computers or computing devices, PDAs, mobile telephones such as smart phones, and other mobile computing devices.

In certain such embodiments, computerized instructions for controlling any games (such as any primary or base games and/or any secondary or bonus games) displayed by the gaming device are executed by the central server, central controller, or remote host. In such “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the gaming device and are stored in at least one memory device of the gaming device. In such “thick client” embodiments, the at least one processor of the gaming device executes the computerized instructions to control any games (or other suitable interfaces) displayed by the gaming device.

In some embodiments in which the gaming system includes: (a) a gaming device configured to communicate with a central server, central controller, or remote host through a data network; and/or (b) a plurality of gaming devices configured to communicate with one another through a data network, the data network is an internet or an intranet. In certain such embodiments, an internet browser of the gaming device is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the gaming device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games and displays those plays via the internet browser of the gaming device.

It should be appreciated that the central server, central controller, or remote host and the gaming device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (Saas).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a processor circuit; and
a memory coupled to the processor circuit, the memory comprising machine-readable instructions that, when executed by the processor circuit, cause the processor circuit to:
determine player information associated with a first player of a wagering game at a gaming device;
embed the player information in a cryptographic token;
transfer the cryptographic token to a player wallet associated with the first player; and
in response to the transfer, provide the embedded player information to a player tracking server.

2. The system of claim 1, wherein the player information comprises identifying information for the first player.

3. The system of claim 1, wherein the player information comprises game play information associated with play of the wagering game at the gaming device by the first player.

4. The system of claim 1, wherein the instructions that cause the processor circuit to embed the player information in the cryptographic token further cause the processor circuit to mint the cryptographic token comprising the player information.

5. The system of claim 1, wherein the instructions that cause the processor circuit to embed the player information in the cryptographic token further cause the processor circuit to modify an existing cryptographic token.

6. The system of claim 1, wherein the cryptographic token comprises a fungible token.

7. The system of claim 1, wherein the cryptographic token comprises a non-fungible token.

8. The system of claim 1, wherein the instructions further cause the processor circuit to:
cause a display device of the gaming device to display a machine-readable code comprising an instruction to redeem the cryptographic token,
wherein a player device associated with the player wallet scanning the code causes the player device to execute the instruction to transfer the cryptographic token to the player wallet.

9. The system of claim 1, wherein the instructions further cause the processor circuit to:
wirelessly receive an instruction to redeem the cryptographic token from a player device associated with the player,
wherein the instruction causes the gaming device to transfer the cryptographic token to the player wallet.

10. The system of claim 1, wherein the instructions further cause the processor circuit to:
cause a ticket printer device of the gaming device to print a redemption ticket comprising a machine-readable code,
wherein a ticket redemption device scanning the code causes the ticket redemption device to execute the instruction to transfer the cryptographic token to the player wallet.

11. The system of claim 1, wherein the instructions that cause the processor circuit to provide the embedded player information to the player tracking server further cause a player device associated with the first player to transmit the embedded player information to the player tracking server.

12. The system of claim 1, wherein the instructions that cause the processor circuit to embed the player information in the cryptographic token further cause the processor circuit to embed the player information in a first block of a blockchain data structure associated with the transfer of the cryptographic token to the player wallet, and
wherein the instructions that cause the processor circuit to provide the embedded player information to the player tracking server further cause the player tracking server to:
determine the first block of the blockchain data structure; and
extract the player information from the first block.

13. The system of claim 12, wherein the instructions further cause the processor circuit to:
encrypt the first player information, wherein the embedded first player information comprises the encrypted first player information, and
wherein the instructions that cause the player tracking server to extract the player information from the first block further cause the player tracking server to decrypt the encrypted player information.

14. The system of claim 1, wherein the player tracking server is operated by a manufacturer of the gaming device.

15. The system of claim 1, wherein the player tracking server is operated by a provider of the wagering game.

16. A gaming device comprising:
a display device;
an input device;
a processor circuit; and
a memory coupled to the processor circuit, the memory comprising machine-readable instructions that, when executed by the processor circuit, cause the processor circuit to:
determine player information associated with a first player of a wagering game at a gaming device;
embed the player information in a cryptographic token;
display, by the display device. a machine-readable code comprising an instruction that, when scanned by a player device associated with a player wallet, causes the player device to transfer the cryptographic token to the player wallet; and
in response to the transfer, provide the embedded player information to a player tracking server.

17. The gaming device of claim 16, wherein the player information comprises identifying information for the first player and game play information associated with play of the wagering game at the gaming device by the first player.

18. The gaming device of claim 16, wherein the instructions that cause the processor circuit to embed the player information in the cryptographic token further cause the processor circuit to mint the cryptographic token comprising the player information.

19. A method comprising:
determining, by a processor circuit, player information associated with a first player of a wagering game at a gaming device;
embedding, by the processor circuit, the player information in a cryptographic token;
transferring, by the processor circuit, the cryptographic token to a player wallet associated with the first player; and
in response to the transfer, providing, by the processor circuit, the embedded player information to a player tracking server.

20. The method of claim 19, wherein embedding the player information in the cryptographic token further comprises minting the cryptographic token comprising the player information.
